(19) United States
(12) Patent Application Publication
(10) Pub. No.: US 2019/0114043 A1
(43) Pub. Date: Apr. 18, 2019

(54) METHOD, APPARATUS, AND ELECTRONIC DEVICE FOR DISPLAYING A PAGE AND STORAGE MEDIUM

(71) Applicant: Beijing Kingsoft Internet Security Software Co., Ltd., Beijing (CN)

(72) Inventor: Sha CAO, Beijing (CN)

(21) Appl. No.: 16/134,365

(22) Filed: Sep. 18, 2018

(30) Foreign Application Priority Data
Oct. 13, 2017 (CN) 201710953880.8

(51) Int. Cl. G06F 3/0483; G06F 3/0485; G06F 3/0488

(52) U.S. Cl. CPC G06F 3/0483; G06F 2203/04806; G06F 3/04886; G06F 3/04855

(57) ABSTRACT

Embodiments of the present application disclose a method, an apparatus, an electronic device for displaying a page and a storage medium, which relates to the field of computer technology, and enables users to quickly find out that there is more display content on the page and to efficiently browse or manipulate the display content. The method comprises: scrolling a current page according to a touch instruction, wherein a display block is arranged on the current page and a first content is displayed in the display block; determining a scroll distance of the current page; and displaying a second content in the display block when the scroll distance of the current page reaches a preset threshold, wherein the second content is different from the first content. The present application can be used for displaying pages in a mobile terminal.

### CROSS REFERENCE TO RELATED APPLICATION

The present application claims the priority to a Chinese patent application No. 201710953880.8, filed with the State Intellectual Property Office of People's Republic of China on Oct. 13, 2017 and entitled “Method, Apparatus, And Electronic Device For Displaying A Page And Storage Medium”, which is hereby incorporated into the present application by reference in its entirety.

### TECHNICAL FIELD

The present application generally relates to the field of computer technology, and more particularly to a method, an apparatus, and an electronic device for displaying a page, and storage medium.

### BACKGROUND

When a large amount of content needs to be displayed during displaying of a page, a part of the content is often hidden at first and will be displayed under the trigger of a user, or different content is displayed in turn at certain intervals.

However, in such a way, the content on the page may not be fully displayed, so that the user may not know that there is more content on the page. Even if the user knows that there is more content, he/she may not bother to scroll the page for browsing or wait for different content to switch. The user's browsing efficiency and the user experience are thereby severely affected.

### SUMMARY

In view of this, embodiments of the present application provide a method, an apparatus, an electronic device and a storage medium for displaying a page, which enables users to quickly find out that there is more display content on the page and to efficiently browse or manipulate the display content.

In a first aspect, an embodiment of the present application provides a method for displaying a page, which is applicable in a mobile terminal. The method includes: scrolling a current page according to a touch instruction, wherein a display block is arranged on the current page and a first content is displayed in the display block; determining a scroll distance of the current page; and displaying a second content in the display block when the scroll distance of the current page reaches a preset threshold, wherein the second content is different from the first content.

In combination with the first aspect, in a first implementation of the first aspect, the number of the display block is one or more than one.

In combination with the first aspect, in a second implementation of the first aspect, before displaying a second content in the display block, the method further includes: detecting whether the display block is within a display area of a screen; and displaying the second content in the display block when the scroll distance of the current page reaches a preset threshold includes: displaying the second content in the display block when the display block is within the display area of the screen and the scroll distance of the current page reaches the preset threshold.

In combination with the first aspect or any one of the first to the second implementations of the first aspect, in a third implementation of the first aspect, displaying the second content in the display block includes at least one of the following operations: displaying the second content in the display block by scrolling the display content in the display block; and displaying the second content in the display block by zooming out the display content in the display block.

In combination with the first aspect, in a fourth implementation of the first aspect, the method includes: detecting whether the display block is within a preset area of the screen; and zooming in the second content when the display block is within the preset area of the screen.

In combination with the third implementation of the first aspect, in a fifth implementation of the first aspect, a scroll direction of the current page is the same as, opposite to, or at a preset angle to a scroll direction of the display content in the display block.

In combination with the fifth implementation of the first aspect, in a sixth implementation of the first aspect, the scroll direction of the current page is the length direction of the screen, and the scroll direction of the display content is the width direction of the screen.

In combination with the first aspect or any one of the first to the second implementations of the first aspect, in a seventh implementation of the first aspect, each of the first content and the second content includes one or more of a picture, an icon, and a text.

In a second aspect, an embodiment of the present application further provides an apparatus for displaying a page, which is applicable in a mobile terminal. The apparatus includes: a scroll unit, configured for scrolling a current page according to a touch instruction, wherein a display block is arranged on the current page and a first content is displayed in the display block; a determination unit, configured for determining a scroll distance of the current page; and a display unit, configured for displaying a second content in the display block when the scroll distance of the current page reaches a preset threshold, wherein the second content is different from the first content.

In combination with the second aspect, in a first implementation of the second aspect, the number of the display block is one or more than one.

In combination with the second aspect, in a second implementation of the second aspect, the apparatus further includes: a detection unit, configured for detecting whether the display block is within a display area of a screen before displaying a second content in the display block; and the display unit is specifically configured for displaying the second content in the display block when the display block is within the display area of the screen and the scroll distance of the current page reaches the preset threshold.

In combination with the second aspect or any one of the first to the second implementations of the second aspect, in the third implementation of the second aspect, the display unit includes at least one of: a scroll adjustment module, configured for displaying the second content in the display block by scrolling the display content in the display block; and a zooming out module, configured for displaying the second content in the display block by zooming out the display content in the display block.

In combination with the second aspect, in a fourth implementation of the second aspect, the display unit is further configured for: detecting whether the display block is within a preset area of the screen; and zooming in the second content when the display block is within the preset area of the screen.

In combination with the third implementation of the second aspect, in a fifth implementation of the second aspect, a scroll direction of the current page is the same as, opposite to, or at a preset angle to a scroll direction of the display content in the display block.

In combination with the fifth implementation of the second aspect, in a sixth implementation of the second aspect, the scroll direction of the current page is the length direction of the screen, and the scroll direction of the display content is the width direction of the screen.

In combination with the second aspect or any one of the first to the second implementations of the second aspect, in the seventh implementation of the second aspect, each of the first content and the second content includes one or more of a picture, an icon, and a text.

In a third aspect, an embodiment of the present application further provides an electronic device, which includes: a housing, a processor, a memory, a circuit board and a power supply circuit, wherein the circuit board is arranged inside a space enclosed by the housing, the processor and the memory are arranged on the circuit board; the power supply circuit is configured to supply power for circuits or components in the electronic device; the memory is configured to store executable program codes; and the processor is configured to execute a program corresponding to the executable program codes by reading the executable program codes stored on the memory for implementing the method for displaying a page provided by any embodiment of the present application.

In a fourth aspect, an embodiment of the present application further provides a computer-readable storage medium, which is configured for storing one or more programs. The one or more programs is executable by one or more processors to implement the method for displaying a page provided by any embodiment of the present application.

In a fifth aspect, an embodiment of the present application further provides an application program. The application program is executed to implement the method for displaying a page provided by any embodiment of the present application.

The method, apparatus, electronic device, and storage medium provided by the embodiment of the present application can scroll the current page to change the display content in the display block on the current page, which makes it easier for the user to find out that there is more display content in the display block such that the content can be easily displayed without additional waits or clicks. Therefore, the browsing efficiency and the user experience are greatly improved.

### BRIEF DESCRIPTION OF THE DRAWINGS

In order to clearly illustrate the technical solutions of the embodiments of the present application or the prior art, some drawings are provided as briefly described below. Obviously, these drawings described below are only for some embodiments of the present application, and those of ordinary skills in the art can obtain other drawings based on these drawings without any creative efforts.

FIG. 1 is a flowchart of a method for displaying a page provided by an embodiment of the present application;

FIG. 2 illustrates a schematic structure of a page in a method for displaying a page provided by an embodiment of the present application;

FIG. 3 is a flowchart of a method for displaying a page based on the page structure shown in FIG. 2;

FIG. 4 illustrates a schematic structure of an apparatus for displaying a page provided by an embodiment of the present application;

FIG. 5 illustrates a schematic structure of an electronic device provided by an embodiment of the present application.

### DETAILED DESCRIPTION

The embodiments of the present application will be described below in detail with reference to the drawings.

It should be understood that the embodiments described are only some of the embodiments of the present application, instead of all the embodiments. All other embodiments obtained by those of ordinary skills in the art based on the embodiments herein without any creative efforts are within the scope of the present application.

In the first aspect, an embodiment of the present application provides a method for displaying a page, which is applicable in a mobile terminal. The method can facilitate a user to find out that there is more content to be displayed in some display blocks on the page, such that the content can be easily displayed without additional waits or clicks, thus greatly improving the browsing efficiency and the user experience.

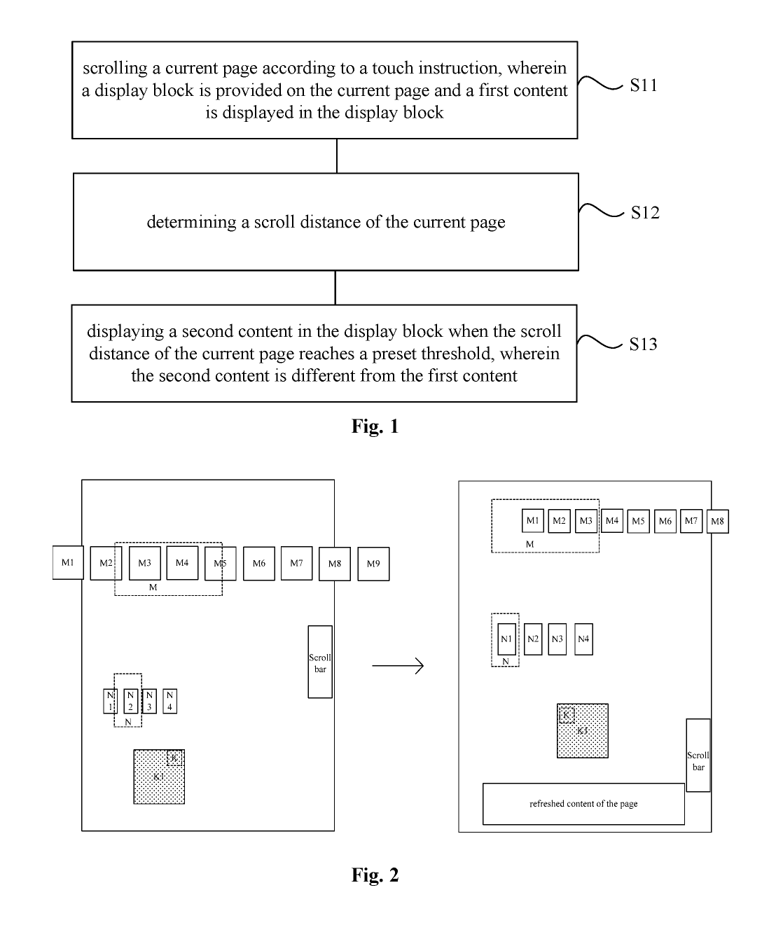

FIG. 1 is a flowchart of a method for displaying a page provided by an embodiment of the present application. As shown in FIG. 1, the method provided by this embodiment can include:

S11, scrolling a current page according to a touch instruction, wherein a display block is provided on the current page and a first content is displayed in the display block.

The current page can be any type of page that can be browsed by a user, such as a web page, a document page, an APP display page, and the like. If the current page has a large length or width, the user has to scroll the page to browse the entire content of the current page. The display block may be a display area in the current page, have a large or small area, and be located anywhere on the current page. The display content in the display block is relatively independent of the other parts of the current page. The display content in the display block is usually difficult to being fully displayed at once in the display block due to the amount or large size of the content. Therefore, the display content may be divided into a plurality of parts, in which the first content is one of the plurality of parts. For example, the display content in the display block can include a set of photos, a large structure diagram, several pages of a document, and the like. The first content can be one of the photos, a partial diagram, or any of the pages. There can be one or more such display blocks distributed in any area in the current page.

S12, determining a scroll distance of the current page.

The scroll distance is a parameter describing the display position of the current page, and can be indicated by the position of the page scroll bar or by the page coordinates or the like. After receiving an instruction for scrolling the current page, the current page starts to scroll, which generates a scroll distance.

S13, displaying a second content in the display block when the scroll distance of the current page reaches a preset threshold, wherein the second content is different from the first content.

In this step, when the scroll distance reaches a preset threshold, for example, the scroll bar reaches a preset pixel point or for preset millimeters, or the changes of the page coordinates reaches a preset distance, the display content in the display block is changed to present the second content that was not previously displayed. The second content is also a part of the display block and is different from the first content. A specific value for the preset threshold can be set as needed to meet requirements of different control accuracy.

For the method provided by the embodiment of the present application, the current page can be scrolled so as to change the display content in the display block on the current page, which makes it easier for the user to find out that there is more display content in the display block such that this content can be easily displayed without additional waits or clicks, thus greatly improving the browsing efficiency and the user experience.

It should be noted that the above embodiment is described in connection with the display changing from the first content to the second content, but the present application is not limited thereto. It should be understand that when the current page is scrolled a lot, each time the scroll distance of the current page exceeds the preset threshold, the display content in the display block would be the changed as described above, and thus the display content can be changed for many times.

Particularly, the display block can be positioned anywhere on the current page, and as the current page is scrolled, the position of the display block in a screen may be changed accordingly. Thus, the display block may be scrolled out of the display area of the screen. Given this, in one embodiment of the present application, before displaying a second content in the display block, the method for displaying a page provided by the embodiment of the present application can further include detecting whether the display block is within the display area of the screen. On this basis, displaying the second content in the display block when the scroll distance of the current page reaches a preset threshold may specifically include displaying the second content in the display block when the display block is within the display area of the screen and the scroll distance of the current page reaches a preset threshold. That is to say, when the display block is scrolled out of the display area of the screen, the user cannot see the content in the display block, and it is unnecessary to adjust the display content in the display block.

Optionally, in the step S13, displaying the second content in the display block may include one or more of the following operations:

displaying the second content in the display block by scrolling the display content in the display block;

displaying the second content in the display block by zooming out the display content in the display block.

Particularly, when displaying the second content in the display block by the scrolling, the current page and the display content in the display block can scroll in various directions, to which the embodiment of the present application is not limited. Optionally, the scroll direction of the current page and the scroll direction of the display content in the display block can be the same, opposite or at a preset angle. For example, in one embodiment of the present application, the scroll direction of the current page may be the direction of the screen, and the scroll direction of the display content may be the width direction of the screen. In another embodiment of the present application, the current page may be scrolled up and down vertically, and the display content in the display block may be scrolled vertically, or may be scrolled horizontally in the left and right direction, or may be scrolled at an angle of 45° to the horizontal.

Further, in order to clearly and observably display the content in the display block, according to an implementation of the present application, the method further includes:

detecting whether the display block is within a preset area of the screen; and

zooming in the second content when the display block is within the preset area of the screen.

Optionally, the preset area may be positioned at various locations on the screen, for example, at the middle of the screen, at the top of the screen, or may be a rectangular area with vertex coordinates of (x1, y1), (x2, y2), (x3, y3), (x4, y4), and the like. Accordingly, the change in the size of the second content would be affected by different positions of the preset area. For example, with different positions of the preset area, the closer the display block is to the center of the screen, the larger the size of the second content is, and the farther the display block is away from the center of the screen, the smaller the size of the second content is; or the closer the display block is to the top of the screen, the larger the size of the second content is and so on, to which the embodiment of the present application is not limited.

For example, in one embodiment of the present application, if the preset area is the central area of the screen, when the distance of the center of the display block from the center line of the screen is less than ¼ of the screen height, the display block enters in the preset area, and the second content can be zoomed in and then displayed in the display block.

Contrary to the zooming in, it can be understood that when displaying the second content in the display block by zooming out, for a display block with a certain size, if the display content is zoomed out, more content can be displayed in the display block at a time, such that the second content that has not been displayed previously can be displayed. In this way, more content can be displayed.

It should be noted that the scrolling and zooming out of the display content in the display block in the above scheme for displaying the second content in the display block can be performed respectively or in combination, to which the embodiment of the present application is not limited. For example, in one embodiment of the present application, the current page is the homepage of a shopping website, in which a display block is provided. The display content in the display block includes three advertisement pictures for displaying promotions for different brands on the website. Here, the three advertisement pictures in the display block can be displayed by scrolling the current page, such that the progress of displaying the advertisement pictures can be controlled conveniently and flexibly. Moreover, the relative position of the display block in the screen is also detected, and the size of each advertisement picture is changed according to the relative position of the display block.

Optionally, the current page may include one or more display blocks. Each of the first content and the second content in the display block can include one or more of a picture, an icon, and a text. For example, in one embodiment of the present application, the current page includes two display blocks, wherein a map is displayed in a display block A, and a document is displayed in a display block B. Here, the map in the display block A and the document in the display block B can be adjusted when scrolling the current page, so as to display different parts of the map and different portions of the document, so that the user can overview the content.

According to the foregoing embodiment, the display content in the display block can be divided into a plurality of parts including the first content and the second content. Here, the first content and the second content can be arranged in various layouts. Optionally, the layout may be a side-by-side tiled layout or a hierarchical expanding layout. With the side-by-side tiled layout, the first content and the second content are tiled and displayed equally in the display block. With the hierarchical expanding layout, the first content and the second content can be hierarchically displayed and expanded as a menu.

The method for displaying a page provided by the embodiment of the present application is described in detail below in connection with a specific embodiment.

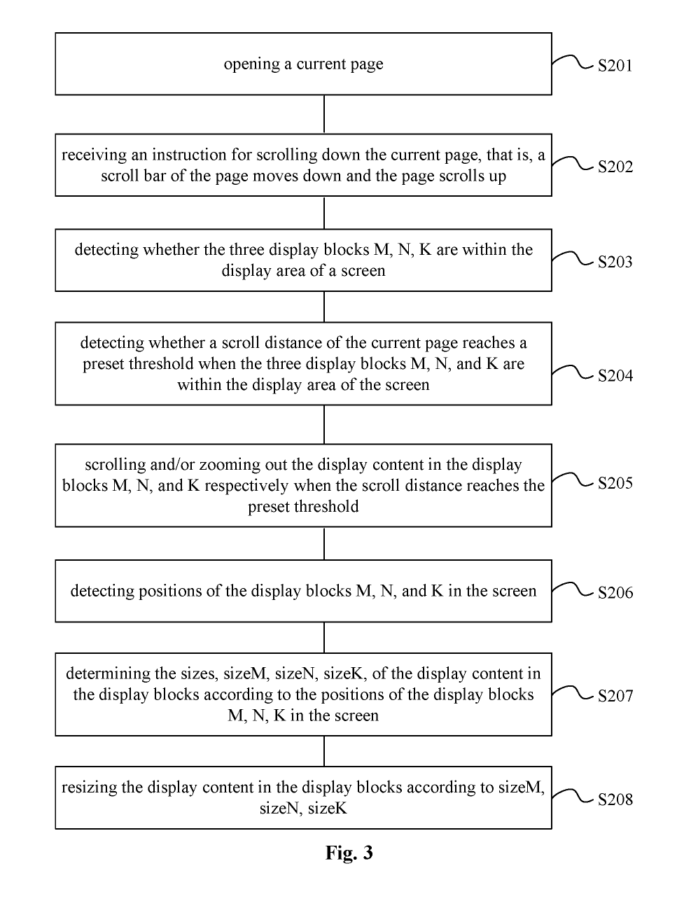

FIG. 2 schematically illustrates a display of a page in an embodiment of the present application, and FIG. 3 is a flowchart of a method for displaying a page based on FIG. 2. With reference to FIG. 2 and FIG. 3, the method for displaying a page provided by an embodiment of the present application can include the following steps.

S201, opening a current page.

The current page is provided with three display blocks M, N, K. The display content of the display block M includes icons M1˜M9, the display content of the display block N includes text boxes N1˜N4, and the display content of the display block K includes a picture K1.

In FIG. 2, display windows of the display blocks are separately indicated by dashed boxes. The display content in the display windows can be displayed and can be seen by users. The display content outside the display windows cannot be seen by users. Here, the amount or size of the display content displayed in each display block is only schematic.

S202, receiving an instruction for scrolling down the current page, that is, a scroll bar of the page moves down and the page scrolls up.

In FIG. 2, the diagram on the left illustrates the arrangement of the page before the scroll bar moves down, and the diagram on the right shows the arrangement of the page after the scroll bar moves down. An arrow between the diagrams on the left and right sides indicates a chronological order, and the diagram on the left side is before the diagram on the right side in time.

It should be noted that the diagram on the right side shown in FIG. 2 may, for example, illustrate the case that the content in the display blocks M, N, and K has been displayed once. In addition, after the display blocks M and/or N and/or K are scrolled out of the user's sight (visible area for the user, i.e., a screen), the icons M1˜M9 and/or the text boxes N1˜N4 and/or the picture K1 can be restored to the original states thereof Alternatively, the icons M1˜M9 and/or the text boxes N1˜N4 and/or the picture K1 are maintained in the current state, which is out of the user's sight.

S203, detecting whether the three display blocks M, N, K are within the display area of a screen.

S204, detecting whether a scroll distance of the current page reaches a preset threshold when the three display blocks M, N, and K are within the display area of the screen.

Optionally, the display blocks M, N, K can correspond to a same preset threshold, and can correspond to different preset thresholds.

S205, scrolling and/or zooming out the display content in the display blocks M, N, and K respectively when the scroll distance reaches the preset threshold.

S206, detecting positions of the display blocks M, N, and K in the screen.

S207, determining the sizes, sizeM, sizeN, sizeK, of the display content in the display blocks according to the positions of the display blocks M, N, K in the screen.

S208, resizing the display content in the display blocks according to sizeM, sizeN, sizeK.

It can be seen from the diagram on the left side and the diagram on the right side in FIG. 2 that, as the scroll bar moves down, the current page scrolls up, the display block M gradually moves away from the center of the screen, and the display content in the display block M scrolls rightward relative to the display block M while the size thereof is decreased; the display block N gradually approaches to the center of the screen, the display content in the display block N scrolls rightward relative to the display block N while the size thereof is increased; and the display content K1 in the display block K scrolls rightward relative to the display block K and the size thereof is unchanged.

This embodiment illustrates a process of the scroll bar moving down. Of course, this method is also applicable to a process in an opposite direction (the scroll bar moving up), in which only the movement direction is opposite. That is, the method of the present application is applicable to a reversible movement.

In the method for displaying a page provided by this embodiment, the display content in the display blocks is adjusted by detecting the scrolling of the page and the positions of the display blocks on the screen, so as to provide the user with richer and clearer content for reading, thus greatly improving the browsing efficiency and the user experience.

In the second aspect, an embodiment of the present application also provides an apparatus for displaying a page, which is applicable in a mobile terminal. The apparatus can facilitate a user to find out that there is more content to be displayed in some display blocks on the page, such that this content can be easily displayed without additional waits or clicks. Therefore, the browsing efficiency and the user experience are greatly improved.

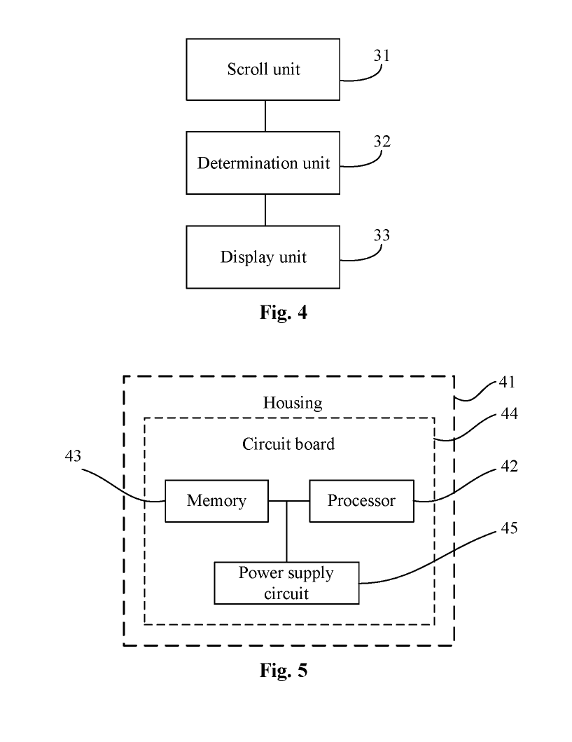

As shown in FIG. 4, the apparatus provided by this embodiment can include:

a scroll unit 31, configured for scrolling a current page according to a touch instruction, wherein a display block is arranged on the current page and a first content is displayed in the display block;

a determination unit 32, configured for determining a scroll distance of the current page;

a display unit 33, configured for displaying a second content in the display block when the scroll distance of the current page reaches a preset threshold, wherein the second content is different from the first content.

For the apparatus provided by the embodiment of the present application, the current page can be scrolled so as to change the display content in the display block on the current page, which makes it easier for the user to find out that there is more display content in the display block such that this content can be easily displayed without additional waits or clicks, thus greatly improving the browsing efficiency and the user experience.

Optionally, the number of the display block may be one or more than one.

Optionally, the apparatus provided by the embodiment of the present application can further include a detection unit, configured for detecting whether the display block is within a display area of a screen before displaying a second content in the display block. On this basis, the display unit 33 can be specifically configured for displaying the second content in the display block when the display block is within the display area of the screen and the scroll distance of the current page reaches the preset threshold.

Optionally, the display unit 33 can include one or more of:

a scroll adjustment module, configured for displaying the second content in the display block by scrolling the display content in the display block; and

a zooming out module, configured for displaying the second content in the display block by zooming out the display content in the display block.

Optionally, the display unit is specifically configured for:

detecting whether the display block is within a preset area of the screen; and

zooming in the second content when the display block is within the preset area of the screen.

Optionally, a scroll direction of the current page is the same as, opposite to, or at a preset angle to a scroll direction of the display content in the display block.

Optionally, the scroll direction of the current page is the length direction of the screen, and the scroll direction of the display content is the width direction of the screen.

Optionally, each of the first content and the second content comprises one or more of a picture, an icon, and a text.

In the third aspect, an embodiment of the present application provides an electronic device, which can facilitate a user to find out that there is more content to be displayed in some display blocks on the page, such that the content can be easily displayed without additional waits or clicks. Therefore, the browsing efficiency and the user experience are greatly improved.

As shown in FIG. 5, an embodiment of the present application provides an electronic device, which can include: a housing 41, a processor 42, a memory 43, a circuit board 44 and a power supply circuit 45, wherein the circuit board 44 is arranged inside a space enclosed by the housing 41, the processor 42 and the memory 43 are arranged on the circuit board 44; the power supply circuit 45 is configured to supply power for circuits or components in the electronic device; the memory 43 is configured to store executable program codes; and the processor 42 is configured to execute a program corresponding to the executable program codes by reading the executable program codes stored on the memory for implementing the method of any embodiment described above.

The specific execution process of the processor 42 for the above steps and a further execution of the processor 42 by executing the executable program code can refer to the description of the embodiments described above and will not be repeated herein.

This electronic device may be embodied in a variety of forms, which includes but is not limited to:

(1) a mobile communication device: such device is characterized in ability of mobile communication and mainly aims to provide voice and data communication. Such terminal includes smart phones (such as IPHONEs), multimedia phones, functional phones, and low-end mobile phones and the like.

(2) an ultra-mobile personal computer device: such device belongs to the category of personal computers, which has functions of computing and processing and generally has mobile networking features. Such terminal includes PDA, MID and UMPC devices and the like, such as IPADs.

(3) a portable entertainment device: such device can display and play multimedia content. Such device includes audio and video players (such as iPods), handhold game consoles, e-books, and smart toys and portable vehicle navigation devices.

(4) a server: a device providing computing service. The server is consisted of a processor, a hard disk, a memory, system bus and on the like. The server is similar to a general computer in architecture, but has a higher requirement in aspects such as processing ability, stability, reliability, security, scalability, manageability due to the need to provide high reliable services.

(5) other electronic devices with data interaction functions.

In a fourth aspect, an embodiment of the present application further provides a computer-readable storage medium, which is configured for storing one or more programs. The one or more programs is executable by one or more processors to implement any method for displaying a page provided by the embodiments described above, and thus, corresponding technical effects can also be achieved, which have been described above in detail and will not be repeated herein.

In a fifth aspect, an embodiment of the present application further provides an application program. The application program can be executed to carry out a method for displaying a page provided by any embodiment of the present application, and thus, corresponding technical effects can also be achieved, which have been described above in detail and will not be repeated herein.

It should be noted that the relationship terms herein such as “first”, “second” and the like, if any, are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a.” or “include(s) a.” do not exclude that there are other identical elements in the processes, methods, articles, or devices which include these elements.

All the embodiments are described in corresponding ways, same or similar parts in each of the embodiments can be referred to one another, and the parts emphasized of each embodiment are differences to other embodiments.

Especially for the embodiment of the device, since it is similar to the embodiment of the method, the description thereof is relatively simple; the relating parts could refer to the parts of the description of the embodiment of the method.

For the convenience of description, the above apparatus is described in individual units/modules according to functions. Of course, the functions of the units/modules can be implemented in one or more software and/or hardware when implementing the present application.

It can be understood by those with ordinary skills in the art that the implementation of all or part of the processes of the methods described above can be accomplished by a program instructing related hardware, and the program can be stored on a computer-readable storage medium. When the program is executed, the process of the embodiment of each method described above can be implemented. The storage medium can be, for example, such as a magnetic disk, an optical disk, a Read-Only Memory (ROM), or a Random Access Memory (RAM).

The above description is only specific embodiments of the present application, and the protection scope of the present application is not limited thereto. Any alteration or substitution that can be easily conceived by those skilled in the art within the technical scope disclosed by the present application shall fall within the protection scope of the present application. Therefore, the protection scope of the present application shall be defined by the claims.

1. A method for displaying a page, which is applicable in a mobile terminal, comprising:
scrolling a current page according to a touch instruction, wherein a display block is arranged on the current page and a first content is displayed in the display block;
determining a scroll distance of the current page; and
displaying a second content in the display block when the scroll distance of the current page reaches a preset threshold, wherein the second content is different from the first content.

2. The method of claim 1, wherein the number of the display block is one or more.

3. The method of claim 1, wherein before displaying a second content in the display block, the method further comprises: detecting whether the display block is within a display area of a screen; and
wherein displaying a second content in the display block when the scroll distance of the current page reaches a preset threshold comprises:
displaying the second content in the display block when the display block is within the display area of the screen and the scroll distance of the current page reaches the preset threshold.

4. The method of claim 1, wherein displaying the second content in the display block comprises at least one of the following operations:
displaying the second content in the display block by scrolling the display content in the display block;
displaying the second content in the display block by zooming out the display content in the display block.

5. The method of claim 1, wherein the method further comprises:
detecting whether the display block is within a preset area of the screen; and
zooming in the second content when the display block is within the preset area of the screen.

6. The method of claim 4, wherein a scroll direction of the current page is the same as, opposite to, or at a preset angle to a scroll direction of the display content in the display block.

7. The method of claim 6, wherein the scroll direction of the current page is the length direction of the screen, and the scroll direction of the display content is the width direction of the screen.

8. The method of claim 1, wherein each of the first content and the second content comprises one or more of a picture, an icon, and a text.

9. An apparatus for displaying a page, which is applicable in a mobile terminal, comprising:
a scroll unit, configured for scrolling a current page according to a touch instruction, wherein a display block is arranged on the current page and a first content is displayed in the display block;
a determination unit, configured for determining a scroll distance of the current page; and
a display unit, configured for displaying a second content in the display block when the scroll distance of the current page reaches a preset threshold, wherein the second content is different from the first content.

10. The apparatus of claim 9, wherein the number of the display block is one or more than one.

11. The apparatus of claim 9, further comprising:
a detection unit, configured for detecting whether the display block is within a display area of a screen; and
wherein the display unit is further configured for displaying the second content in the display block when the display block is within the display area of the screen and the scroll distance of the current page reaches the preset threshold.

12. The apparatus of claim 9, wherein the display unit comprises at least one of:
a scroll adjustment module, configured for displaying the second content in the display block by scrolling the display content in the display block; and
a zooming out module, configured for displaying the second content in the display block by zooming out the display content in the display block.

13. The apparatus of claim 9, wherein the display unit is further configured for:
detecting whether the display block is within a preset area of the screen; and
zooming in the second content when the display block is within the preset area of the screen.

14. The method of claim 12, wherein a scroll direction of the current page is the same as, opposite to, or at a preset angle to a scroll direction of the display content in the display block.

15. The apparatus of claim 14, wherein the scroll direction of the current page is the length direction of the screen, and the scroll direction of the display content is the width direction of the screen.

16. The apparatus of claim 9, wherein each of the first content and the second content comprises one or more of a picture, an icon, and a text.

17. An electronic device, comprising: a housing, a processor, a memory, a circuit board and a power supply circuit, wherein the circuit board is arranged inside a space enclosed by the housing, the processor and the memory are arranged on the circuit board; the power supply circuit is configured to supply power for circuits or components in the electronic device; the memory is configured to store executable program codes; and the processor is configured to execute a program corresponding to the executable program codes by reading the executable program codes stored on the memory for implementing the method for displaying a page of claim 1.

18. A non-transitory computer-readable storage medium, which is configured for storing one or more programs, wherein the one or more programs is executable by one or more processors to implement the method for displaying a page of claim 1.
